(19) United States
(12) Patent Application Publication
(10) Pub. No.: US 2025/0024979 A1
(43) Pub. Date: Jan. 23, 2025

(54) DOMESTIC STEAM-COOKING APPLIANCE HAVING A STEAM TREATMENT

(71) Applicant: BSH Hausgeräte GmbH, Munich (DE)

(72) Inventors: Ludovic Ball, Sessenheim (FR); Stefan Diederichs, Sternenfels (DE)

(21) Appl. No.: 18/708,622

(22) PCT Filed: Nov. 10, 2022
(86) PCT No.: PCT/EP2022/081548

§ 371 Date: May 15, 2024

(30) Foreign Application Priority Data
Dec. 1, 2021 (DE) 102021213618.4

(51) Int. Cl. A47J 27/04

(52) U.S. Cl. CPC A47J 27/04; A47J 2027/043

(57) ABSTRACT

A household steam-cooking appliance includes a drawer extendible out of a drawer housing horizontally to a front and including a front reservoir portion receiving a water reservoir, and an evaporator tank portion arranged behind the reservoir portion and receiving an evaporator tank. A pivotably arranged lid covers an open top side of the evaporator tank in a steam-tight manner when the drawer is fully retracted into the drawer housing. The drawer is extendible out of its fully retracted position into an intermediate position in which the reservoir portion projects out of the drawer housing for filling the water reservoir and the lid covers the open top side of the evaporator tank in the steam-tight manner. The drawer is extendible out of its intermediate position into a fully extended final position in which the lid is pivotably automatically against the evaporator tank such as to define a gap therebetween.

The invention relates to a household steam-cooking appliance, having a drawer which can be extended out of a drawer housing horizontally to the front, wherein the drawer has a front reservoir portion, which is designed to receive a water reservoir, and an evaporator tank portion, which is arranged behind the reservoir portion and is designed to receive an evaporator tank, and the household steam-cooking appliance has a lid which, when the drawer is in a fully retracted position, covers an open top side of the evaporator tank in a steam-tight manner. The invention also relates to a method for extending a drawer out of a drawer housing of a household steam-cooking appliance. The invention can be applied particularly advantageously to multi-cavity household cooking appliances in which the household steam-cooking appliance is arranged below a further cooking appliance, for example an oven and/or microwave appliance.

Ovens with a full-size cooking chamber above which a warming compartment is arranged are known. The front loading openings of the cooking chamber and warming compartment can be closed in each case by pivotable doors which are hinged on the front side.

Double ovens with a full-size cooking chamber and a smaller cooking chamber arranged therebelow are also known, wherein a front loading opening of the top cooking chamber can be closed by a pivotable door which is hinged on the front side, while the bottom cooking chamber is embodied as a drawer which can be pulled out to the front.

Furthermore, double-deck cooking appliances with a top steamer cavity and an oven arranged therebelow are known. The front loading openings of the steamer cavity and cooking chamber can be closed in each case by pivotable doors which are hinged on the front side.

In addition, a cooking appliance is known which has a passive cooking chamber divider which, when inserted, divides the cooking chamber into two partial cooking chambers which are largely separate from one another in functional and thermal terms.

It is the object of the present invention to at least partially overcome the disadvantages of the prior art and in particular to provide a steam-cooking drawer which can be operated in a particularly hazard-free and user-friendly manner.

This object is achieved in accordance with the features of the independent claims. Preferred embodiments are described in particular in the dependent claims.

The object is achieved by a household steam-cooking appliance having a (steam treatment) drawer which can be extended out of a drawer housing horizontally to the front, which
has (viewed from the front) a front portion (“reservoir portion”), which is designed to receive a water reservoir of the drawer, and (viewed from the front) a portion arranged behind the reservoir portion (“evaporator tank portion”), which is embodied to receive an evaporator tank of the drawer,
has a pivotably arranged lid which, when the drawer is in a position in which it is fully retracted into the drawer housing, covers an open top side of the evaporator tank in a steam-tight manner,
can be extended out of its fully retracted position into an intermediate position in which the reservoir portion projects out of the drawer housing for filling the water reservoir and the lid covers the open top side of the evaporator tank in a steam-tight manner, and
can be extended out of its intermediate position into a fully extended final position in which the lid can be pivoted automatically against the evaporator tank such that there is a gap therebetween.

This household steam-cooking appliance has the advantage that a user can extend the drawer as far as the intermediate position without the danger of being wetted with hot steam, and can then fill the water reservoir easily in the intermediate position without steam escaping from a steam treatment compartment formed by the evaporator tank and the lid in the process, as a result of which the danger of being burned by escaping steam is to a large extent reduced. A further advantage consists in that the steam atmosphere in the steam treatment compartment is not disturbed when the water reservoir is refilled and as a result a cooking result is not impaired.

When the drawer is extended further, beyond the intermediate position, the gap is opened automatically or autonomously and steam escapes therethrough initially with a low volumetric flow, in contrast to the billowing-out which would occur if the lid were immediately opened fully, thus further reducing the likelihood of the user being wetted with steam. Once sufficient steam has escaped through the gap, a user can advantageously fully open the lid easily and safely in the final position.

In one development, the gap opens continuously over a predetermined pull-out distance of the drawer. This results in the advantage that a slow escape of steam through the gap is ensured particularly safely or an initial billowing-out of steam is avoided particularly safely.

In one development, the intermediate position corresponds to a certain extension path of the drawer. In one development, the intermediate position corresponds to a certain region of the extension path of the drawer, within which the conditions described above (projection or exposure of the water reservoir and steam-tight coverage of the evaporator tank) are fulfilled.

The drawer serves to hold or receive at least the evaporator tank and the water reservoir as well as other components that may be required, such as an evaporator which can be refilled from the water reservoir. Water transferred into the evaporator from the water reservoir is brought to the boil for a steam treatment process in the evaporator, and the steam thus produced is guided into the evaporator tank. For this purpose, the evaporator can have for example at least one heating element, advantageously arranged on the base side. In one development, the heating element can be operated electrically.

That the reservoir portion projects from the drawer housing in the intermediate position for filling the water reservoir comprises in particular that a user then has access to the water reservoir in order to fill it.

In one development, the water reservoir is a water reservoir which can be removed in particular in an upward direction from the reservoir portion. For this purpose, the water reservoir is in particular accommodated removably, in particular in an upwardly removable manner, in a reservoir receptacle of the reservoir portion and, in the opposite direction, can be inserted into a corresponding receptacle in the reservoir portion. This results in the advantage that the filling of the water reservoir, for example with fresh water, can be carried out particularly easily, and furthermore that no water flows onto other components of the drawer during the refilling process.

Alternatively, the water reservoir can be installed in the reservoir portion in a fixed manner. It can then have for example a filler opening, through which it can be filled with water by a user. The filler opening can be coverable for example by a cover which can be removed by a user. In one development, the water reservoir can be open on the top side, where it can be covered by means of a cover.

In one development, the drawer has or bears an evaporator, and the evaporator is arranged in the reservoir portion of the drawer. The evaporator can be attached to the drawer in a fixed manner or can be removable by a user.

In one development, the water reservoir with the evaporator form a common, in particular commonly operable unit (“evaporator/reservoir unit”). In one development, the evaporator/reservoir unit can be removed from the drawer in the intermediate position for filling the water reservoir and then reinserted.

In one development, the lid is or has a glass pane. In one development, the lid (when viewed from the front) has handle regions on the left and right side. These enable operation of the lid such that it can be opened and closed without the danger of burning on a hot glass pane. The handle regions can consist for example of plastic or another material with a lower thermal conductivity than glass. In one development, the glass pane is surrounded entirely by a plastic edge.

In one development, the lid can be removable by the user, for example for cleaning purposes.

In the fully retracted position of the drawer, the lid covers the open top side of the evaporator tank in an at least largely steam-tight manner. For this purpose, a seal can be present between the evaporator tank and lid, which seal can be attached to the evaporator tank or to the lid. The closed lid leaves the reservoir portion exposed, in other words does not cover it. The fully retracted position of the drawer corresponds to the usual or normal position for a steam treatment mode in which for example the evaporator can be operated.

That the evaporator tank portion is located behind the reservoir portion when viewed from the front comprises that, when the drawer is extended, initially its reservoir portion and only then the evaporator tank portion projects out of the drawer housing. In the intermediate position, at least the reservoir portion projects out of the drawer housing. In the intermediate position, the evaporator tank portion can still be disposed within the drawer housing or can project slightly from the drawer housing, but in each case such that the lid covers the open top side of the evaporator tank in a steam-tight manner. The evaporator tank can be installed on the evaporator tank portion in a fixed manner or can advantageously be removable by a user, in particular in an upward direction.

The lid can be fully openable in the final position at the latest, in one embodiment for example by being lifted up manually. Food to be cooked can then be removed from the evaporator tank, or the evaporator tank can be removed from the drawer and reinserted.

In one embodiment,
the lid is arranged on the drawer such that it can be pivoted in the region of its rear edge,
at least one spring-supported plunger is arranged on the drawer and lifts the lowered lid in an upward direction by the gap in the unloaded state, and
the drawer housing has at least one press-on element, which presses the lid at least between the fully closed state and the intermediate position of the drawer against the at least one plunger such that the lid presses onto the evaporator tank in a steam-tight manner and in the final position exerts no force onto the lid.

This results in the advantage that a secure, steam-tight pressing of the lid against the spring force of the at least one plunger onto the evaporator tank at least as far as the intermediate position can be achieved in a mechanically simple and robustly implementable manner, and when the drawer is extended a long way a pivot movement of the lid with a defined gap width (for example between 1 cm and 2 cm) is effected by the plungers. In the final position of the drawer, the lowered lid rests on the plungers without being subject to a load, in other words only on account of its weight, which plungers then keep the lid open by the width of the gap on account of their spring force. The gap has its greatest gap height or width at the front edge of the lid (when viewed from the front). The plunger can be supported by a mechanical spring such as a helical spring or the like. The plunger can however also be a plunger of a pneumatic spring.

In one embodiment, the press-on element has a rod arranged at right angles to a direction of movement of the drawer in a horizontal direction, on which rod at least one rotatable roller is arranged, which at least one roller presses onto a top side of the lid at least between the fully closed state and the intermediate position of the drawer. This results in the advantage that the press-on element is in contact with the lid in a practically wear-free manner. When the drawer is moved between the closed position and the intermediate position, the rollers roll off on the top side of the lid.

The at least one rotatable roller can comprise in particular two rotatable rollers, which are arranged above a side edge of the lid when viewed from the front. This advantageously exerts a particularly low mechanical load on the lid.

In one embodiment, the at least one roller is rolled off from the lid in the final position of the drawer. As a result, it no longer exerts any force counter to the spring force of the at least one plunger, and also does not lie in the way of the fully open lid. When the drawer is pushed in, the at least one roller rolls back onto the lid and after a short distance presses it once again onto the evaporator tank in a steam-tight manner.

Because the force exerted counter to the plungers in a downward direction on the front edge of the lid subsides continuously as the drawer moves up, the use of the rollers advantageously makes it possible to achieve, in a simple manner in terms of design, that the lid is continuously opened further and further up to the maximum height of the plungers over a certain pull-out distance after the intermediate position. This advantageously causes the steam to escape particularly slowly through the gap.

In one embodiment, the at least one spring-supported plunger is arranged below a front edge of the lid when the lid is lowered.

The at least one spring-supported plunger can comprise in particular two plungers, which when viewed from the front are arranged below the front edge of the lid when the lid is lowered, in particular at a left-side and right-side end. This advantageously exerts a particularly low mechanical load on the lid, specifically if the press-on element comprises two rotatable rollers, which are arranged above a side edge of the lid when viewed from the front.

In one embodiment, the evaporator tank can be removed from the drawer, in particular in an upward direction, when the lid is lifted up. This results in the advantage that steam-treated food to be cooked can be removed particularly easily, namely together with the evaporator tank. In addition, the evaporator tank is as a result particularly easy to clean. For this purpose, the evaporator tank can have for example handles on the left and right side.

In one embodiment, the drawer can be lockable in the intermediate position and/or in the final position in a manner that can be released or overcome. In the intermediate position and/or in the final position, the drawer is therefore held mechanically in such a stable manner that components present on the drawer, such as the water reservoir, the lid, the evaporator tank and so on, can advantageously be handled by a user in a safe and defined manner, in other words without undesired displacement of the drawer, which in turn facilitates handling. That the drawer is locked in its intermediate position and/or in its final position in a manner that can be overcome comprises in particular that the drawer can be released from the position only with the application of an appreciable or significant force along the extension direction, for example by pressing the drawer in the direction of the drawer housing in order to move it into its fully retracted position, or by pulling or pressing the drawer out of the intermediate position in order to move it into the final position.

In one embodiment, the drawer can be moved in an autonomous or automatic manner, initiated by the user, from its fully retracted position into the intermediate position, for example by means of a spring or motor-driven mechanism. This results in the advantage of a particularly high level of user-friendliness, in particular because in this way it is possible to dispense with an unwieldy grasping of the drawer in the fully retracted state.

In an alternative or additional development, the drawer can be pulled manually by a user out of its closed position into the intermediate position, namely purely manually or for example by means of a spring-supported mechanism. This can be implemented in a particularly cost-effective manner.

In one embodiment, the household steam-cooking appliance has a push-pull mechanism, which can be initiated by a user, for moving the drawer out of its fully retracted position into the intermediate position. This results in the advantage that an autonomous movement of the drawer with mechanically simple and proven means can be implemented robustly and reliably. Here, the user only has to push the drawer slightly into the drawer housing in order to initiate the push-pull mechanism, thus initiating a spring mechanism which moves the drawer autonomously into the intermediate position. Manually pressing the drawer into the drawer housing re-tensions the push-pull mechanism and locks it until it is actuated once again by a user.

In one embodiment, the drawer can be pulled manually out of the intermediate position into the final position. This results in the advantage of a particularly simple implementation. To this end, the user must grasp the drawer and apply a force in the extension direction which is sufficiently great to move the drawer into its final position.

In one embodiment, the drawer has a front cover plate (which can also be referred to as a screen or faceplate), which has regions (“projecting regions”) projecting to the side (in other words to the left and right side when viewed from the front), which are provided as handle regions for manually pulling the drawer out, in particular from its intermediate position. In this way, the advantage is achieved that the hands of a user are well away from the open top side of the evaporator tank and in addition are arranged therebelow so that, even if the lid opens after the intermediate position is exceeded, the risk of the user's hands being exposed to hot steam is very low.

In particular, also with reference to this embodiment, the drawer can have a support frame connected to the drawer, which can be retracted fully into the drawer housing and comprises the reservoir portion and the evaporator tank portion. The cover plate is present on the front of the support frame, projecting laterally over the support frame when viewed from the front and there having or providing the projecting regions.

Alternatively, the drawer can be movable out of the intermediate position into the final position in an autonomous or automatic manner by means of a mechanism which can be actuated or initiated by a user, for example by means of a motor-driven mechanism.

In one embodiment, an evaporator, which is arranged on the drawer, in particular in the reservoir portion, and which can be refilled from the water reservoir, can be operated in the intermediate position. In this way, the advantage is achieved that, during a steam treatment mode, the evaporator continues to run while the water reservoir is being refilled, for example with fresh water, and as a result the steam atmosphere in the steam treatment compartment is advantageously disturbed to a particularly minimal extent. It is however also possible that the evaporator cannot be operated in the intermediate position, for example because it is uncoupled or disconnected electrically or in terms of control technology when the drawer is extended out of the fully retracted position. This can be advantageous in terms of safety aspects.

The household steam-cooking appliance can be a stand-alone household appliance, in particular a household appliance which can be installed on a stand-alone basis.

The object is achieved by a household cooking appliance having at least one household steam-cooking appliance as described above and in addition at least one further cooking appliance with a separate cooking chamber (“multi-cavity” household cooking appliance). The household cooking appliance can be embodied in an analogous manner to the household steam-cooking appliance, and vice versa, and has the same advantages. In this way, the advantage is achieved that, by means of the household cooking appliance, food to be cooked can be steam-treated individually in the household steam-cooking appliance and, independently thereof, other food to be cooked can be heat-treated in the further cooking appliance.

In one development, the at least one further cooking appliance is an oven (possibly also with pyrolytic capability), a microwave appliance, a steam-cooking appliance, a vacuum-cooking appliance or any combination thereof, for example an oven with microwave functionality or the like.

In one development, the further cooking appliance has a front loading opening, which can be closed by means of a pivotable door.

In one embodiment, the above steam-cooking appliance is arranged below a further cooking appliance. In this way, the advantage is achieved that food to be cooked can be easily loaded into and removed from a compact household steam-cooking appliance.

If the household cooking appliance has at least one further cooking appliance in addition to the at least one steam-cooking appliance, in one development they can be operated via a common user interface, for example an operator control panel arranged on the at least one further cooking appliance. In addition or alternatively, the steam-cooking appliance can be operable via a separate user interface. In general, the user interface can also be implemented on a mobile user terminal device such as a smartphone or tablet PC, for example by means of a corresponding application program (“app”).

The object is further achieved by a method for extending a drawer out of a drawer housing of a household steam-cooking appliance, which drawer has a reservoir portion for receiving a water reservoir of the drawer and an evaporator tank portion arranged behind the tank portion for receiving an evaporator tank, wherein in the method
in a position of the drawer in which it is fully retracted into the drawer housing, a lid arranged pivotably on the drawer covers an open top side of the evaporator tank in a steam-tight manner,
the drawer is moved out of its fully retracted position into an intermediate position in which the reservoir portion projects out of the drawer housing for filling the water reservoir and the lid covers the open top side of the evaporator tank in a steam-tight manner.

This method can be embodied in an analogous manner to the household steam-cooking appliance and the household cooking appliance, and vice versa, and has the same advantages.

That the reservoir portion projects out of the drawer housing for filling the water reservoir comprises in particular that the water reservoir is exposed and can be handled by a user for filling, for example with fresh water, for example can be removed for this purpose.

In one embodiment, the drawer is extended out of the first intermediate position into a fully extended final position, and in this process the lid is automatically pivoted against the evaporator tank in such a way that a gap is opened therebetween.

In one embodiment, the lid is arranged pivotably on the drawer in the region of its rear edge, at least one spring-supported plunger is arranged on the drawer, which plunger lifts the lowered lid in an upward direction by the gap in the unloaded state, and the drawer housing has a rod which is arranged at right angles to a direction of movement of the drawer in a horizontal direction, on which rod at least one rotatable roller is arranged, wherein
in the fully retracted position of the drawer, the at least one rotatable roller presses the lid onto the evaporator tank in a steam-tight manner,
the at least one roller rolls backward relative to the lid when the drawer is moved into the intermediate position, and
the at least one roller rolls off from the lid when the drawer is moved out of its intermediate position into a fully extended final position.

The above-described properties, features and advantages of this invention and the manner in which these are achieved will become clearer and more readily understandable in connection with the following schematic description of an exemplary embodiment, which will be described in further detail making reference to the drawings.

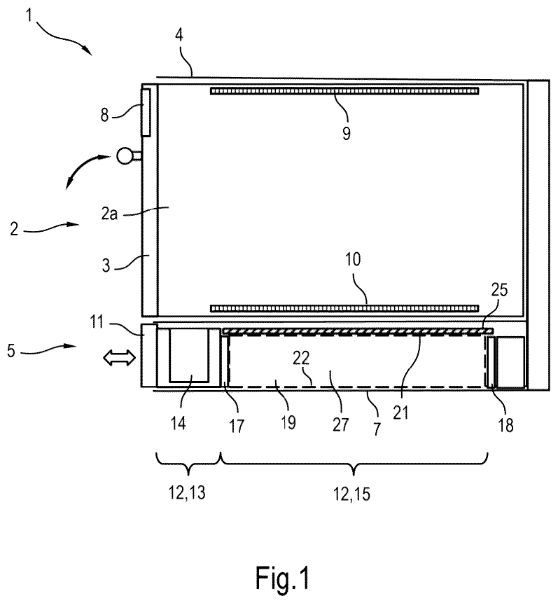

FIG. 1 shows as a sectional representation in a side view a drawing of a multi-cavity household cooking appliance with a drawer-type steam-cooking appliance;

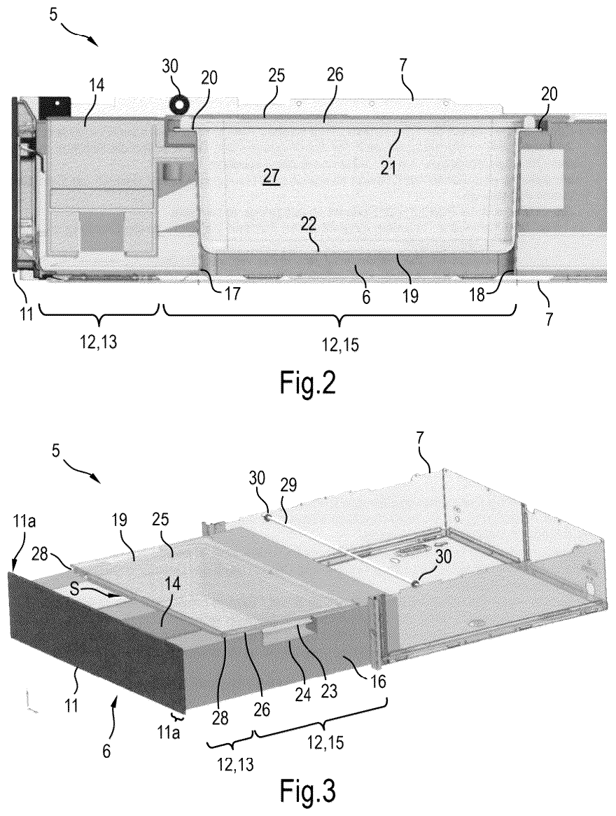

FIG. 2 shows the steam-cooking appliance as a sectional representation in a side view with the drawer fully retracted;

FIG. 3 shows the steam-cooking appliance in an oblique top view with the drawer fully extended and the lid resting on top;

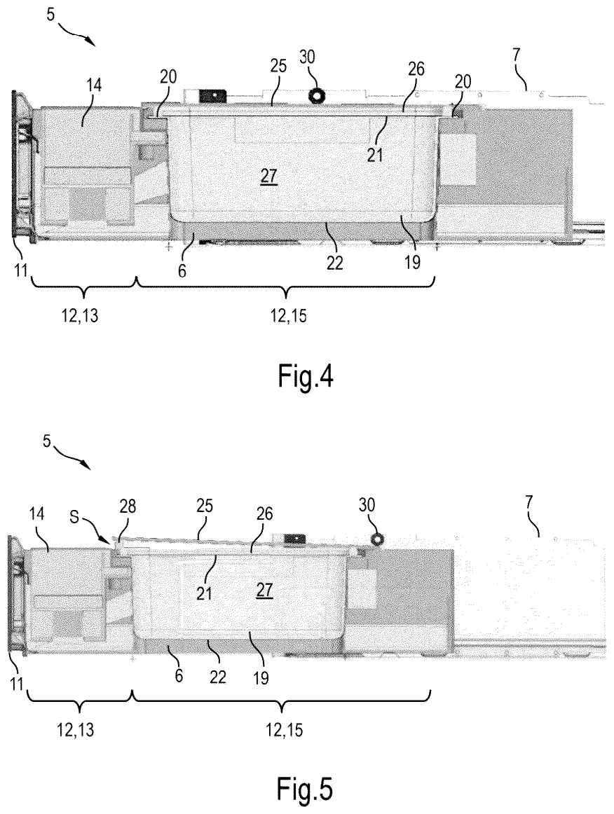

FIG. 4 shows the steam-cooking appliance as a sectional representation in a side view with the drawer in the intermediate position;

FIG. 5 shows the steam-cooking appliance as a sectional representation in a side view with the drawer in a position between the intermediate position and the final position;

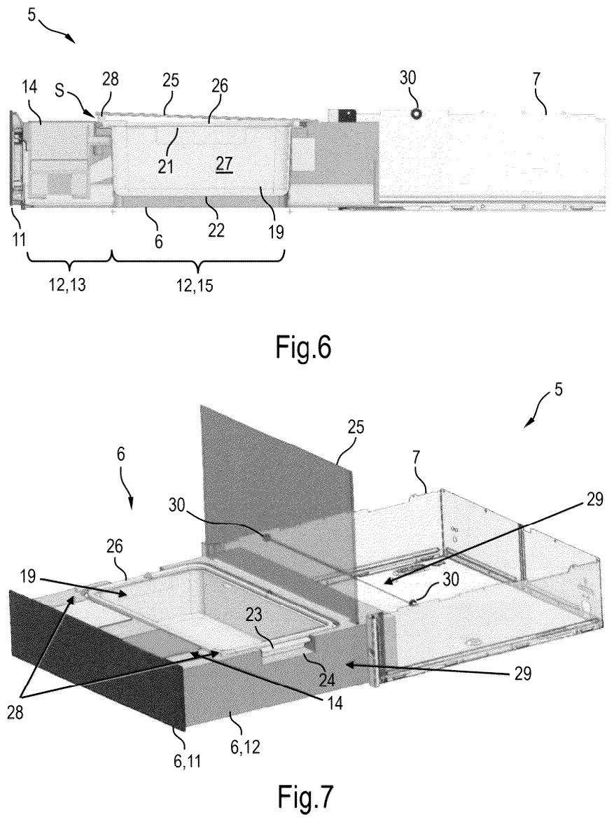

FIG. 6 shows the steam-cooking appliance as a sectional representation in a side view with the drawer in the final position; and

FIG. 7 shows the steam-cooking appliance in an oblique top view with the drawer fully extended and the lid fully open.

FIG. 1 shows as a sectional representation in a side view a drawing of a “multi-cavity” household cooking appliance 1 with an oven 2, the stationary oven compartment 2a of which can be closed at the front by means of a pivotable oven door 3, as indicated by the curved double arrow. Within a housing 4 of the household cooking appliance 1 below the oven 2, there is a steam-cooking appliance 5, arranged separately from the oven 2 and having a (steam treatment) drawer 6, which can be moved horizontally in and out of a stationary drawer housing 7, as indicated by the straight double arrow. The steam-cooking appliance 5 has a lower height than the oven 2.

The oven door 3 contains a common appliance controller 8, including a user interface for the oven 2 and the steam-cooking appliance 5. The oven 2 and the steam-cooking appliance 5 can be actuated individually by means of the appliance controller 8, so that items to be treated which are located therein, for example food to be cooked such as foodstuffs, dishes and the like, can be prepared independently of one another. The oven compartment 2a can be heated by means of apparatuses for the introduction of energy in the form of a top heating element 9 shown in the drawing by way of example and a bottom heating element 10, in particular through clocked operation of a respective power supply. The heating elements 9 and 10 are actuated by way of the appliance controller 8. The appliance controller 8 is in particular also configured to coordinate treatment processes running in the oven compartment 2a and in the steam treatment drawer 6, in particular end times of the treatment processes, energy inputs and/or exhaust air control.

The household cooking appliance 1 is in particular sufficiently compact to fit into an installation niche of 60 cm×60 cm (installation height×installation width).

Now also with reference to FIG. 2 and FIG. 3, the drawer 6 has a support frame 12, which is arranged behind a front cover plate 11 and can be moved horizontally against the drawer housing 7, which support frame can be retracted fully into the drawer housing 7. When the drawer 5 is fully retracted, the cover plate 11 is flush with a front side of the household cooking appliance 1, in particular also the oven door 3. The cover plate 11 projects beyond the support frame 12 on the left and right side, wherein the projecting regions 11a can be used as handle regions for grasping and pulling out the drawer 6.

The support frame 12 has a front-side reservoir portion 13, directly adjacent to the cover plate 11, in which reservoir portion an evaporator (not shown) and a water reservoir 14 fluidically connected thereto are accommodated. Here, at least the water reservoir 14 can by way of example be removed from the reservoir portion 13.

An evaporator tank portion 15 is located behind the reservoir portion 13 when viewed from the front. Said evaporator tank portion 15 takes the form of a surround with lateral supports 16, a front wall 17 and a rear wall 18. At least the supports 16 are embodied as hollow profiles, here with a rectangular cross-section, as a result of which they are particularly lightweight and allow electrical cables (not shown), for example electrical cables for supplying power to heating elements for the evaporator and where appropriate signal cables, to be guided through in a protected manner. Running rails (not shown), for example of a pull-out mechanism in the form of a telescopic pull-out system of the steam treatment drawer 5, are also accommodated in the hollow supports 16. A further advantage when using hollow profiles consists in that they enable a wide top supporting surface for supporting an evaporator tank 19 to be embodied in a simple manner. Here, at least the supports 16 and the rear wall 18 have level surfaces, making them easy to clean. The front wall 17 and the rear wall 18 can likewise be embodied as hollow profiles or as simple walls without a hollow profile. Their top sides can likewise serve as supporting surfaces, but do not need to do so.

The evaporator tank 19 is embodied to be tank- or dish-shaped, namely here with a cuboid base shape which is open at the top. The evaporator tank 19 has on its top side a laterally outward-curved, circumferentially closed flange 20, by way of which it can be placed from above onto the supporting surfaces. The evaporator tank 19 can therefore be inserted from above into the evaporator tank portion 15. The top opening 21 of the evaporator tank 19 forms a loading opening for inserting items to be steam-treated, for example food to be cooked.

In the region surrounded laterally by the supports 16 and the walls 17, 18, the evaporator tank portion 15 has no base. When the evaporator tank 19 is inserted, its base 22 forms a partial region of the base of the steam treatment drawer 5 within the surround 16 to 18. As a result, the evaporator tank 19 can be embodied to be particularly deep with a correspondingly large volume. Furthermore, a base of the support frame 12 is dispensed with there, which advantageously results in a material saving.

The evaporator tank 19 further has laterally projecting handles 23 for easy handling which, when the evaporator tank 19 is inserted, can be fitted into a respective cut-out, open at the top, of the lateral supports 16 in the form of respective recesses 24.

The steam treatment drawer 5 also has a lid 25, which can be placed onto the top side of the flange 20 of the evaporator tank 19 by way of a circumferential, in particular elastic seal 26, and in the closed position prevents or at least hinders steam from escaping out of the evaporator tank 19. The evaporator tank 19 and the lid 25 form or delimit a steam treatment compartment 27, in which steam can be applied to the items to be treated which are disposed therein.

The lid 25 is arranged pivotably on the drawer 6 on its rear edge and, in the lowered position, rests on two spring-supported plungers 28 in the region of the front edge, as shown in FIG. 3 for the fully extended drawer 6. The plungers 28 force the front edge of the lid 25 in an upward direction against its weight, so that the lid 25 is pivoted slightly in the unloaded state and above all is open at the front edge by a gap S relative to the evaporator tank 19. As a result, steam D present in the evaporator tank 19 can escape through the gap S, advantageously however not in a billowing manner as would be the case if the lid 25 were lifted up, but instead with a comparatively low volumetric flow. The gap height, which advantageously amounts to between 1 cm and 2 cm, can be set in a targeted manner through the selection of the plungers 28. If a force which is greater than the spring force of the plungers 28 is exerted from above onto the lid 25, the lid 25 continues to be lowered onto the seal 26 and closes the top opening of the evaporator tank 19 in a steam-tight manner.

As shown in FIG. 2 and FIG. 3, the drawer housing 7 has a rod 29 with rotatable rollers 30 in a top and front region. Here, the rod 29 can be rotatable and the rollers 30 can be attached in a fixed manner to the rod 29, or the rod 29 is not rotatable, whereas the rollers 30 can rotate against the rod 29.

As shown in FIG. 2, when the drawer 6 is fully retracted, the rollers 30 press the front edge of the lid 25 in a downward direction against the spring force exerted in an upward direction by the plungers 28, so that the lid 25 is pressed onto the seal in a steam-tight manner.

As shown in FIG. 3, when the drawer 6 is fully extended, the rollers 30 are located behind the lid 25, so that they exert no force onto it and the lid 25 is therefore pivoted in an upward direction by a gap width on the front edge by the plungers 28.

The process of extending the drawer 6 fully starting from its fully retracted position described in FIG. 2 will now be described in more detail:

FIG. 4 shows the steam-cooking appliance 5 as a sectional representation in a side view with the drawer 6 in the intermediate position. This is achieved for example by actuating a push-pull mechanism (not shown), wherein the lid 25 is moved forward below the rollers 30 between the fully retracted position and the intermediate position. In this process, the rollers 30 press the lid 25 onto the seal 26 against the force of the plungers 28 in a steam-tight manner. The reservoir portion 13 of the support frame 12 is located outside the drawer housing 7, so that the water reservoir 14 is exposed for filling.

The evaporator (not shown) can continue to be operated in the intermediate position or can alternatively be deactivated.

FIG. 5 shows the steam-cooking appliance 5 as a sectional representation in a side view with the drawer 6 in a position between the intermediate position and the final position. The rollers 30 now rest on a rear edge of the lid 25 over the pivot axis of the lid 25 and therefore no longer exert sufficient downwardly acting torque onto the lid 25 in order to hold the front edge thereof in a steam-tight manner on the evaporator tank 19 against the upwardly acting force of the plungers 28. The plungers 28 have therefore pushed the front edge of the lid 25 in an upward direction to form a gap S, through which for example steam can escape from the evaporator tank 19. In this position, the evaporator is advantageously deactivated.

The use of the rollers 30 makes it possible to achieve, in a simple manner in terms of design, that the lid 25 is continuously opened further and further up to the maximum height of the plungers 28 over a certain pull-out distance, as the force exerted counter to the plungers 28 in a downward direction on the front edge of the lid 25 subsides continuously as the drawer 6 moves up.

FIG. 6 shows the steam-cooking appliance 5 as a sectional representation in a side view with the drawer 6 in the fully extended final position. Here, the lid 25 is now fully extended out of the drawer housing 7, and the rollers 30 no longer press onto the lid 25, but instead have rolled off therefrom. It is now possible for a user, if necessary a short while after allowing steam to escape, to grasp the lid and open it fully by pivoting it into the vertical position.

FIG. 7 shows the steam-cooking appliance 5 in an oblique top view with the drawer 6 fully extended and the lid 25 fully open and in the vertical position. It is now possible for a user to load the evaporator tank 19 or to grasp the evaporator tank 19 by its handles 23 and remove it from the support frame 12.

In order to start or continue a steam-cooking mode, the lid 25 is placed back onto the plungers 28 and then the drawer 6 is pushed through the intermediate position and into the fully retracted position, in particular manually, for example by pressing the cover plate 11 in the direction of the drawer housing 7. Upon reaching the position shown in FIG. 5, the rollers 30 move onto the lid 25 and press it closed again as it is retracted further, so that the lid 25 once again covers the evaporator tank 19 in a steam-tight manner at the latest in the intermediate position.

In order to only refill the water reservoir 14, the user can also push the drawer 6 out of the intermediate position back into its fully retracted position, as a result of which the push-pull mechanism is once again tensioned and locked.

The present invention is naturally not restricted to the exemplary embodiment shown.

For example, the intermediate position and/or the final position can be positions which are lockable in a manner which can be overcome, but do not have to be.

In addition, the drawer can be moved purely manually, in other words without a push-pull mechanism. Furthermore, the drawer can be moved in a purely motor-driven manner.

In general, “a”, “an”, etc. can be understood as singular or plural, in particular in the sense of “at least one” or “one or several”, etc., provided this is not explicitly excluded, for example by the expression “exactly one”, etc.

A numerical value can also include the given value as well as a typical tolerance range, provided this is not explicitly excluded.

### LIST OF REFERENCE CHARACTERS

1 Household cooking appliance
2 Oven
2a Oven compartment
3 Oven door
4 Housing of the household cooking appliance
5 Steam-cooking appliance
6 Steam treatment drawer
7 Drawer housing
8 Appliance controller
9 Top heating element
10 Bottom heating element
11 Cover plate
12 Support frame
13 Reservoir portion of the support frame
14 Water reservoir
15 Evaporator tank portion
16 Side support of the support frame
17 Front wall of the support frame
18 Rear wall of the support frame
19 Evaporator tank
20 Flange of the evaporator tank
21 Top opening of the evaporator tank
22 Base of the evaporator tank
23 Handle of the evaporator tank
24 Recess in the side support
25 Lid
26 Seal
27 Steam treatment compartment

1-14. (canceled)

15. A household steam-cooking appliance, comprising a drawer extendible out of a drawer housing horizontally to a front, the drawer comprising:
a front reservoir portion designed to receive a water reservoir,
an evaporator tank portion arranged behind the reservoir portion and designed to receive an evaporator tank,
a pivotably arranged lid designed to cover an open top side of the evaporator tank in a steam-tight manner when the drawer assumes a position in which the drawer is fully retracted into the drawer housing,
wherein the drawer is extendible out of its fully retracted position into an intermediate position in which the reservoir portion projects out of the drawer housing for filling the water reservoir and the lid covers the open top side of the evaporator tank in the steam-tight manner, and
wherein the drawer is extendible out of its intermediate position into a fully extended final position in which the lid is pivotably automatically against the evaporator tank such that there is a gap between the lid and the evaporator tank.

16. The household steam-cooking appliance of claim 15, wherein the lid is arranged pivotably on the drawer in a region of a rear edge thereof, said drawer comprising a spring-supported plunger designed to lift the lid in an upward direction by the gap in an unloaded state, when the lid is lowered, said drawer housing comprising a press-on element designed to press the lid at least between a fully closed state and the intermediate position of the drawer against the plunger such that the lid presses onto the evaporator tank in the steam-tight manner and to exert no force onto the lid in the final position of the drawer.

17. The household steam-cooking appliance of claim 16, wherein the press-on element comprises a rod arranged at a right angle to a direction of movement of the drawer in a horizontal direction, and a roller arranged on the rod and designed to press onto a top side of the lid at least between the fully closed state and the intermediate position of the drawer.

18. The household steam-cooking appliance of claim 17, wherein the roller is rolled off from the lid in the final position of the drawer.

19. The household steam-cooking appliance of claim 16, wherein the spring-supported plunger is arranged below a front edge of the lid when the lid is lowered.

20. The household steam-cooking appliance of claim 15, wherein the lid is liftable up manually in the final position of the drawer.

21. The household steam-cooking appliance of claim 20, wherein the evaporator tank is designed for removal in an upward direction out of the drawer when the lid is lifted up.

22. The household steam-cooking appliance of claim 15, wherein the drawer is lockable in a releasable manner in the intermediate position and/or in the final position.

23. The household steam-cooking appliance of claim 15, wherein the drawer is moveable in an autonomous manner, initiated by a user, from the fully retracted position into the intermediate position, and pullable manually out of the intermediate position into the final position.

24. The household steam-cooking appliance of claim 15, further comprising an evaporator arranged on the drawer and refillable from the water reservoir, said evaporator designed to operate in the intermediate position.

25. The household steam-cooking appliance of claim 24, wherein the evaporator is arranged in the reservoir portion of the drawer.

26. A household cooking appliance, comprising:
a steam-cooking appliance comprising a drawer extendible out of a drawer housing horizontally to a front, the drawer comprising a front reservoir portion designed to receive a water reservoir, and an evaporator tank portion arranged behind the reservoir portion and designed to receive an evaporator tank, a pivotably arranged lid designed to cover an open top side of the evaporator tank in a steam-tight manner when the drawer assumes a position in which the drawer is fully retracted into the drawer housing, wherein the drawer is extendible out of its fully retracted position into an intermediate position in which the reservoir portion projects out of the drawer housing for filling the water reservoir and the lid covers the open top side of the evaporator tank in the steam-tight manner, and wherein the drawer is extendible out of its intermediate position into a fully extended final position in which the lid is pivotably automatically against the evaporator tank such that there is a gap between the lid and the evaporator tank; and
a further cooking appliance arranged above the steam-cooking appliance.

27. A method for extending a drawer out of a drawer housing of a household steam-cooking appliance, with the drawer comprising a front reservoir portion for receiving a water reservoir of the drawer, and an evaporator tank portion arranged behind the reservoir portion for receiving an evaporator tank, the method comprising:
when the drawer is fully retracted into the drawer housing, causing a lid arranged pivotably on the drawer to cover an open top side of the evaporator tank in a steam-tight manner; and
when the drawer is moved out of its fully retracted position into an intermediate position in which the water reservoir projects out of the drawer housing, enabling a filling of the water reservoir and causing the lid to cover the open top side of the evaporator tank in the steam-tight manner.

28. The method of claim 27, further comprising, when the drawer is extended out of the intermediate position into a fully extended final position, causing the lid to automatically pivot against the evaporator tank in such a way that a gap is opened between the lid and the evaporator tank.

29. The method of claim 28, wherein the lid is arranged pivotably on the drawer in a region of a rear edge thereof, wherein the drawer comprises a spring-supported plunger designed to lift the lid in an upward direction by the gap in an unloaded state, when the lid is lowered, and wherein the drawer housing comprises a rod arranged at a right angle to a direction of movement of the drawer in a horizontal direction and a rotatable roller arranged on the rod, the method further comprising:
when the drawer assumes the fully retracted position, causing the roller to press the lid onto the evaporator tank in the steam-tight manner;
when the drawer is moved into the intermediate position, causing the roller to roll backward relative to the lid; and
when the drawer is moved out of the intermediate position into the fully extended final position, causing the roller to roll off the lid.
